(19) United States
(12) Patent Application Publication
(10) Pub. No.: US 2023/0117980 A1
(43) Pub. Date: Apr. 20, 2023

(54) SYSTEMS AND METHODS FOR GRAPH PROTOTYPICAL NETWORKS FOR FEW-SHOT LEARNING ON ATTRIBUTED NETWORKS

(71) Applicant: Arizona Board of Regents on Behalf of Arizona State University, Tempe, AZ (US)

(72) Inventors: Kaize Ding, Tempe, AZ (US); Jianling Wang, College, TX (US); Huan Liu, Tempe, AZ (US)

(73) Assignees: Arizona Board of Regents on Behalf of Arizona State University, Tempe, AZ (US); The Texas A&M University System, College Station, TX (US)

(21) Appl. No.: 17/938,589

(22) Filed: Oct. 6, 2022

Related U.S. Application Data
(60) Provisional application No. 63/255,754, filed on Oct. 14, 2021.

(51) Int. Cl. G06N 3/08; G06K 9/62

(52) U.S. Cl. CPC G06N 3/08; G06K 9/6215; G06K 9/6232; G06K 9/628; G06K 9/6296

(57) ABSTRACT

A system employs Graph Prototypical Networks (GPN) for few-shot node classification on attributed networks, and a meta-learning framework trains the system by constructing a pool of semi-supervised node classification tasks to mimic the real test environment. The system is able to perform meta-learning on an attributed network and derive a highly generalizable model for handling the target classification task. The meta-learning framework addresses extraction of meta-knowledge from an attributed network for few-shot node classification, and identification of the informativeness of each labeled instance for building a robust and effective model.

### CROSS-REFERENCE TO RELATED APPLICATIONS

This is a U.S. Non-Provisional Patent Application that claims benefit to U.S. Provisional Patent Application Ser. No. 63/255,754 filed 14 Oct. 2021, which is herein incorporated by reference in its entirety.

### GOVERNMENT SUPPORT

This invention was made with government support under 1614576 awarded by the National Science Foundation. The government has certain rights in the invention.

### FIELD

The present disclosure generally relates to node classification in attributed networks, and in particular, to a system and associated method for semi-supervised few-shot learning on attributed networks using Graph Prototypical Networks.

### BACKGROUND

Due to its strong modeling capability, attributed networks have been increasingly used to model a myriad of graph-based systems, such as social media networks, citation networks and gene regulatory networks. Among various analytical tasks on attributed networks, node classification is an essential one that has a broad spectrum of applications, including social circle learning, document categorization, and protein classification, to name a few. Briefly, the objective is to infer the missing labels of nodes given a partially labeled attributed network. To tackle this problem, plenty of approaches have been proposed in the research community and demonstrated promising performance.

Prevailing approaches for the node classification problem usually follow a supervised or semi-supervised paradigm, which typically relies upon the availability of sufficient labeled nodes for all the node classes. Nonetheless, in many real-world attributed networks, a large portion of node classes only contain a limited number of labeled instances, rendering a long-tail distribution of node class labels. As shown in FIG. 1, DBLP is a dataset where nodes represent publications and node labels denote venues. Among all the node classes, more than 30% of them have less than 10 labeled instances. In the meantime, many practical applications require the learning models to possess the capability of dealing with such few-shot classes. A typical example is the intrusion detection problem on traffic networks, where new attacks and threats are continuously being developed by adversaries. Due to the intensive labeling cost, for a specific type of attack, only a few examples can be accessed. Thus, understanding those attacks by type with limited labeled data is crucial for providing effective countermeasures. The shortage of labeled training data hinders existing node classification algorithms from learning an effective model with those few-shot node classes. As such, it is challenging yet imperative to investigate the problem of node classification on attributed networks under the few-shot setting.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a histogram showing distribution of labeled nodes in a real-world DBLP dataset;

FIG. 2 is a simplified diagram showing a system for classification of nodes using a Graph Prototypical Network (GPN);

FIGS. 3A and 3B are a pair of diagrams showing generation of prototype representations and resultant predicted class labels for unlabeled nodes in an attributed network by the system of FIG. 2;

FIG. 3C is a diagram showing an architecture of a node valuator module of the system of FIG. 2;

FIGS. 4A and 4B are a pair of diagrams showing a meta-learning framework that trains the system of FIG. 2;

FIGS. 5A-5D are a series of graphical representations showing performance comparison between datasets with respect to text class size;

FIGS. 6A-6D are a series of graphical representations showing performance comparison between datasets with respect to different support size size;

FIGS. 7A-7D are a series of graphical representations showing performance comparison between datasets with respect to query size on a 5-way 5-shot node classification task;

FIGS. 8A and 8B are a series of graphical representations showing a similarity matrix on a dataset using the system of FIG. 2;

FIGS. 9A and 9B are a pair of process flow diagrams showing a method for node classification by the system of FIG. 2;

FIGS. 10A and 10B are a pair of process flow diagrams showing a method for training the system of FIG. 2 for node classification tasks by the meta-learning framework of FIGS. 4A and 4B; and

FIG. 11 is a simplified diagram showing an example computing device for implementation of the system of FIG. 2.

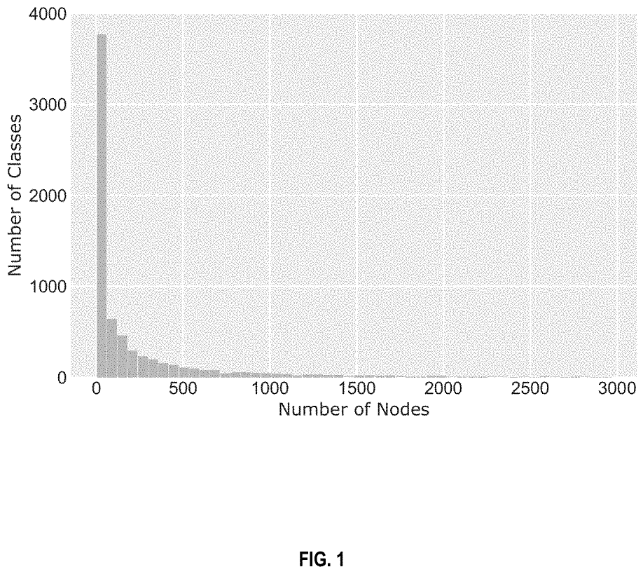

Corresponding reference characters indicate corresponding elements among the view of the drawings. The headings used in the figures do not limit the scope of the claims.

### DETAILED DESCRIPTION

The present disclosure describes a Graph Prototypical Network system (GPN), and in particular, a graph meta-learning system for solving the problem of few-shot node classification on attributed networks. Instead of classifying nodes directly, GPN learns a transferable metric space in which the label of a node is predicted by finding the nearest class prototype. The disclosed system includes two essential components that seamlessly work together for learning the prototype representation of each class. Specifically, the system includes a network encoder that first compresses an input network to expressive node representations via graph neural networks (GNNs), to capture the data heterogeneity of an attributed network. The system further includes a GNN-based node valuator that concurrently estimates the informativeness of each labeled instance, by leveraging additional information encoded in the input network. In this way, the GPN system derives highly robust and representative class prototypes. Moreover, by performing meta-learning across a pool of semi-supervised node classification tasks, the GPN system gradually extracts the meta-knowledge on an attributed network and further achieves improves generalization ability on target few-shot classification tasks.

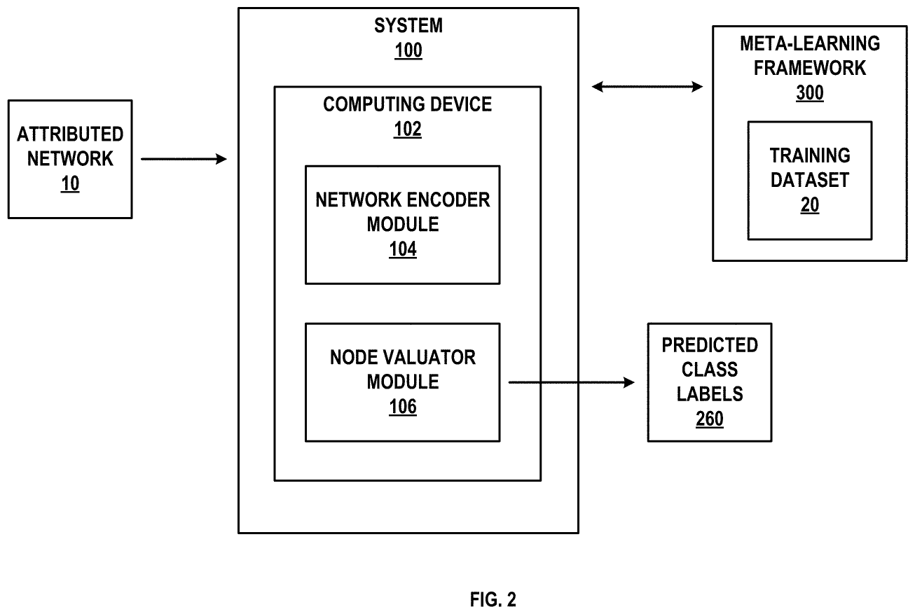

The present disclosure outlines a a GDN-based system, hereinafter “system 100” shown in FIG. 2, which exploits graph neural networks and meta-learning to learn a powerful few-shot node classification model on attributed networks. This disclosure further provides validation results for the system 100 tested on various real-world datasets to corroborate the effectiveness of the present approach. The experimental results demonstrate the superior performance of GPN for few-shot node classification on attributed networks.

### 1. Problem Statement

Recently, much research progress has been made in few-shot learning (FSL), for solving tasks (e.g., classification) with only a handful of labeled examples. In general, an FSL model learns across diverse meta-training tasks sampled from those classes with a large quantity of labeled data and can be naturally generalized to a new task (i.e., meta-test task) from unseen classes during training. Such a meta-learning procedure enables the model to adapt knowledge from previous experiences and has led to significant progress in FSL problems. Specifically, a major line of research such as Siamese networks, matching networks, and relation networks attempts to make the prediction by comparing the query instances and labeled examples in a shared metric space. These learning-to-compare approaches have come into fashion due to their simplicity and effectiveness.

Despite their fruitful success, few-shot learning on attributed networks remains largely unexplored, mainly because of the following two challenges: (i) The process of constructing those meta-training tasks depends on the assumption that data is independent and identically distributed (i.i.d.), which is invalid on attributed networks. Apart from conventional text or image data, attributed networks lie in non-Euclidean space and encode the inherent dependency between nodes. Directly grafting existing methods is infeasible to capture the underlying data structure, making the embedded node representations less expressive. Thus, learning how to exert the power of meta-learning on attributed networks is indispensable for extracting the meta-knowledge from data; and (ii) Most of the existing FSL approaches simply assume that all the labeled examples are of equal importance for characterizing their belonged classes. However, neglecting the individual informativeness of labeled nodes will inevitably restrict the model performance on real-world attributed networks: On the one hand, it makes the FSL model highly vulnerable to noise or outliers since labeled data is severely limited; on the other hand, it runs counter to the fact that the significance of a node could largely deviate from another. Intuitively, those central (core) nodes in a community are supposed to be more representative. Hence, how to capture the informativeness of each labeled node is the other challenge for building an effective few-shot classification model on attributed networks.

Following commonly used notations, this disclosure uses calligraphic fonts, bold lowercase letters, and bold uppercase letters to denote sets (e.g., [symbol] ), vectors (e.g., x), and matrices (e.g., X), respectively. The i^{th} row of a matrix X is denoted by xᵢ, and the transpose of a matrix X is represented as X^{T}. The main notations used throughout the paper are summarized in Table 1.

TABLE 1
Table of main symbols.

| Symbols | Definitions |
|---|---|
| G | input attributed network |
| A | adjacency matrix |
| X | attribute matrix |
| [symbol] | meta-training task in episode t |
| Sₜ | support node set in task [symbol] |
| Qₜ | query node set in task [symbol] |
| W | trainable parameter matrix |
| hᵢ^{l} | hidden representation of node υᵢ in l^{th} layer |
| zᵢ | final latent representation of node υᵢ |
| p_{c} | prototype representation of node class c |
| sᵢ^{l} | importance score of node υᵢ in l^{th} layer |
| deg(i) | in-degree of node υᵢ |
| C(i) | centrality score of node υᵢ |
| \check{s}ᵢ | centrality-adjusted importance score of node υᵢ |
| ŷᵢ* | predicted class label of query node of υᵢ* |

Formally, an attributed network 10 can be represented as G=(ν, ε, χ), where ν denotes a set of nodes {ν₁ν₂, . . . , νₙ} (e.g., a plurality of nodes 12 of the attributed network 10) and ε denotes a set of edges {e₁, e₂, . . . , eₘ}. Each respective node 12 is associated with a feature vector χᵢ∈ [symbol] ^{1×d} and [X=x₂; . . . xₙ]∈ [symbol] ^{n×d} denotes all the features of the node 12. Thus, more generally, the attributed network 10 can be represented as G=(A, X), where A={0, 1}^{nxn} is an adjacency matrix representing the network structure. Specifically, A_{i,j}=1 indicates that there is an edge between node vᵢ and node vⱼ otherwise, A_{i,j}=0. The studied problem can be formulated as follows.

### Problem Definition 1. Few-Shot Node Classification on Attributed Networks:

Given an attributed network 10 [symbol] ={A, X}, suppose there are substantial labeled nodes for a set of node classes Cₜᵣₐᵢₙ. After training on the labeled data from Cₜᵣₐᵢₙ, the model is tasked to predict labels for the nodes (i.e., query set Q) from a disjoint set of node classes Cₜₑₛₜ, for which only a few labeled nodes of each class (i.e., support set S) are available.

Following the common setting in FSL, if Cₜₑₛₜ includes N classes and the support set S includes K labeled nodes per class, this problem is named N-way K-shot node classification problem. In essence, the objective of this problem is to learn a meta-classifier that can be adapted to new classes with only a few labeled nodes. Therefore, learning how to extract transferable meta-knowledge from Cₜᵣₐᵢₙ is the key for solving the studied problem.

### 2. Graph Prototypical Networks

As existing FSL models are not tailored for graph-structured data, it is infeasible to apply them to solve the studied problem directly. Details about system 100 employing Graph Prototypical Networks (GPN) for few-shot node classification on attributed networks are disclosed herein. Specifically, the system 100 is designed and built to address several areas of research:
Performing meta-learning on attributed networks (non-i.i.d. data) for extracting meta-knowledge.
Learning expressive node representations from an attributed network 10 by considering both the node attributes and topological structure.
Identifying the informativeness of each labeled node for learning robust and discriminative class representations.

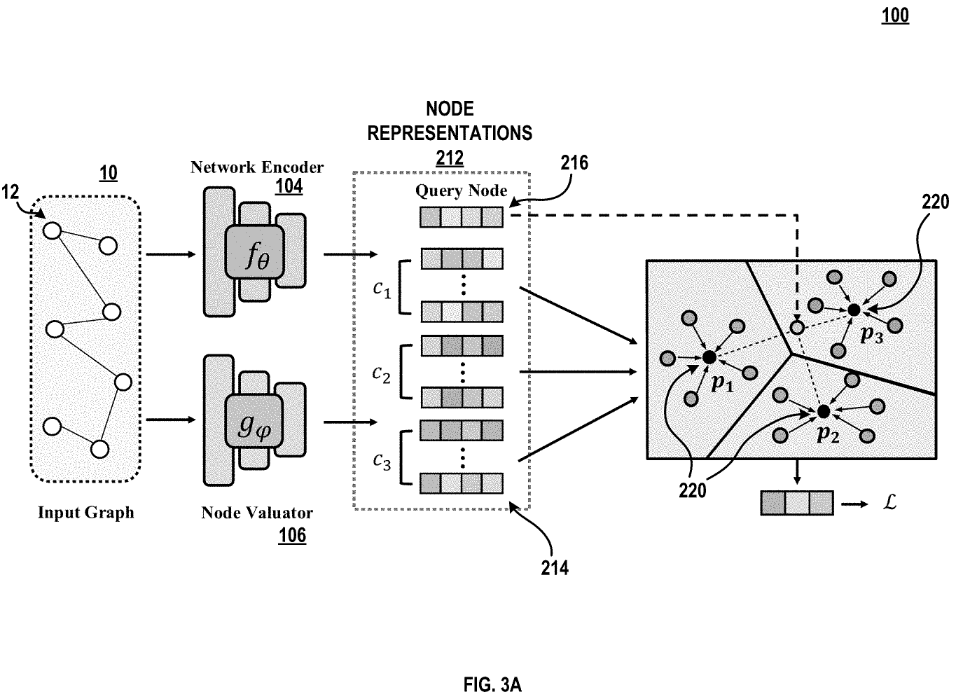

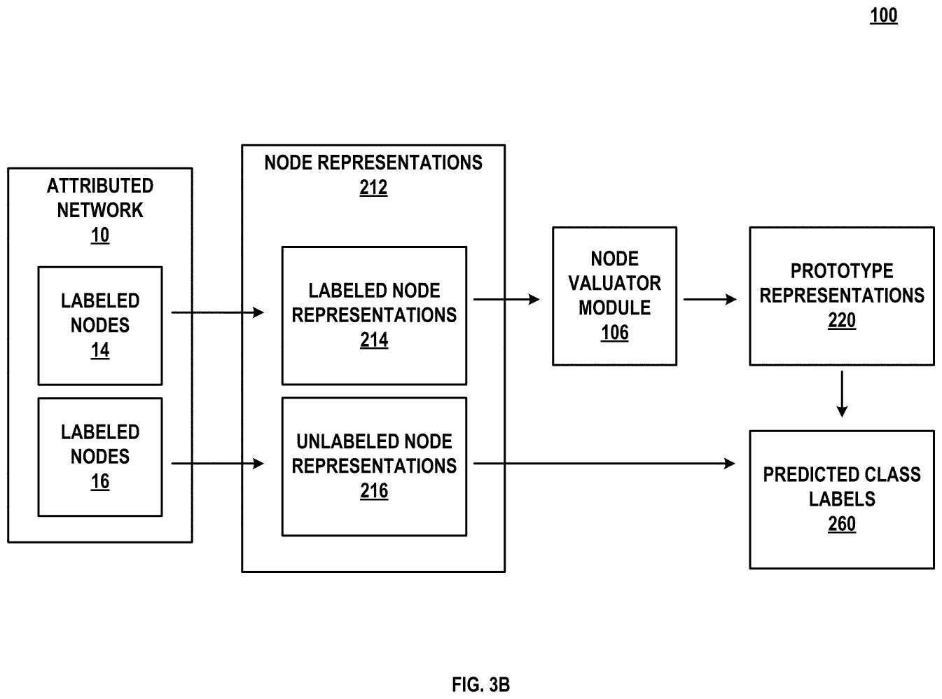

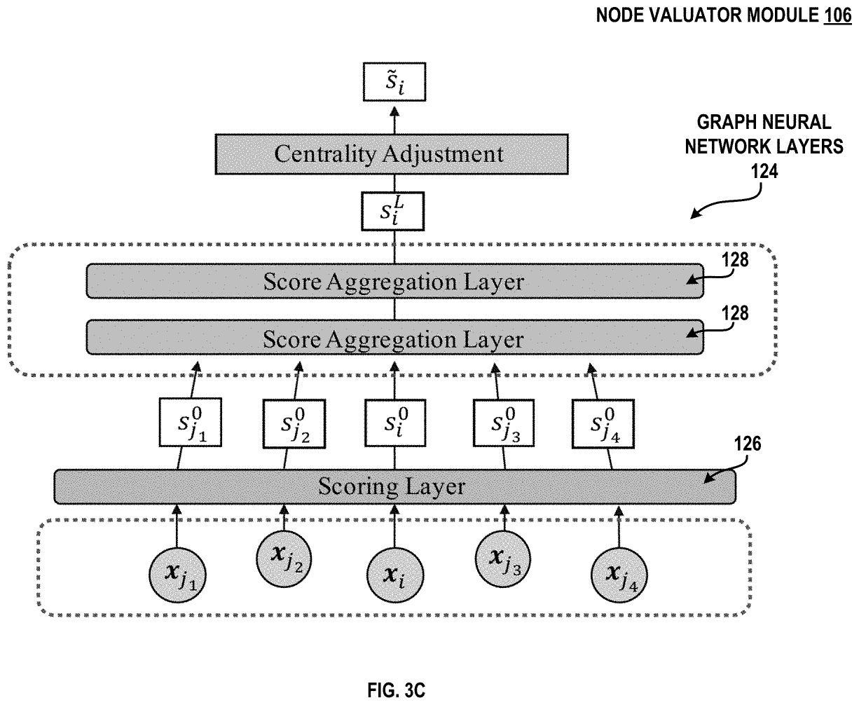

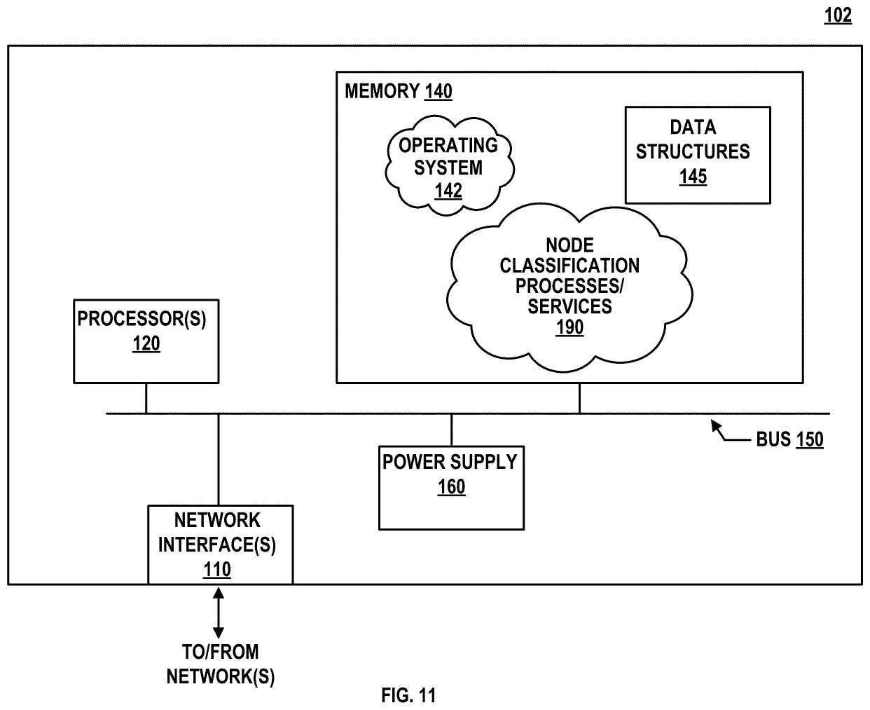

An overview of the system 100 for node classification using a new sub-type of network model called Graph Prototypical Networks (GPN) is provided in FIGS. 2-3C. The system 100 can be computer-implemented and can include a computing device 102 (FIG. 11) including one or more processors 120 that apply various methods described herein with respect to the system 100. The system 100 classifies a plurality of unlabeled nodes 16 within an attributed network 10 by learning a transferable metric space (e.g., a graph) in which a classification label (e.g., a class) of an unlabeled node 16 is predicted by finding a nearest class prototype representation. One issue that the system 100 aims to solve is how to infer missing labels of nodes within the partially labeled attributed network 10. As such, the system 100 uses the GPN to predict a class label of an unlabeled node 16 in a previously-unseen attributed network 10 by extracting, at a network encoder module 104 of the system 100, an unlabeled node representation 216 of the unlabeled node 16 and examining how the unlabeled node representation 216 “clusters” around a set of prototype representations 220 that represent classes identified from a support set (e.g., a plurality of labeled nodes 14 of the attributed network 10). The system 100 can further improve the set of prototype representations 220 by adjusting the centrality of “clusters” (indicative of different classes) of nodes to accurately reflect the “most important” prototype representations 220 at the center of each cluster/class. The system 100 determines a predicted class label 260 of each unlabeled node 12 in the attributed network 10 (e.g., the input graph), where the system 100 determines a predicted class label 260 of each unlabeled node 12 based on similarity of the unlabeled node representation 216 in a clustered graph with respect to the set of prototype representations 220 as determined by a network encoder module 106 of the system 100. In one aspect, the network encoder module 104 and/or the network encoder module 106 can each include a plurality of graph neural network layers; in particular, the network encoder module 106 can be a graph prototypical network having a plurality of graph neural network layers 124 including a scoring layer 126 and one or more score aggregation layers 128, as will be discussed in greater detail herein.

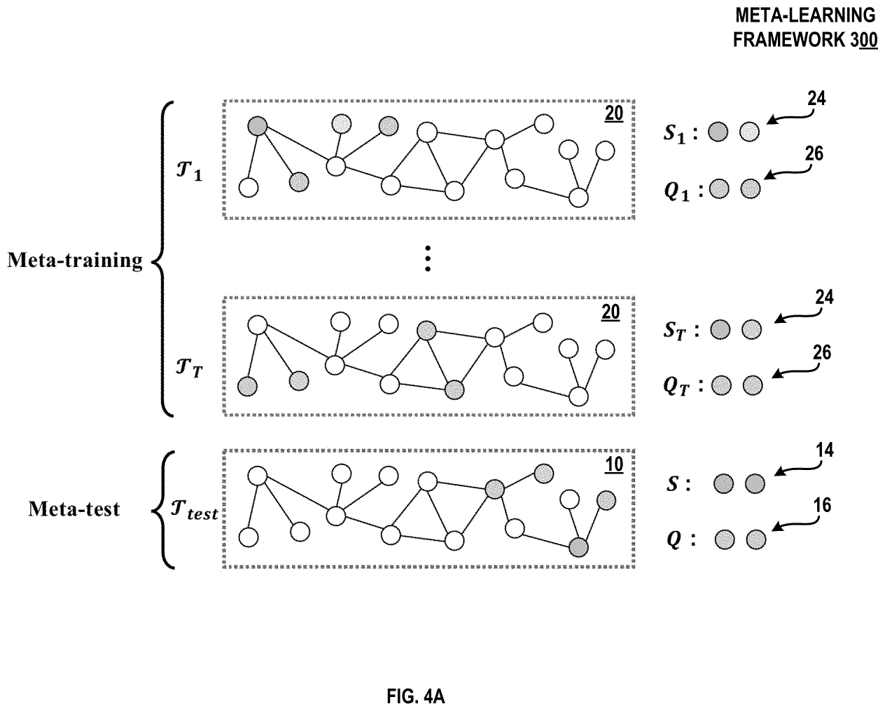

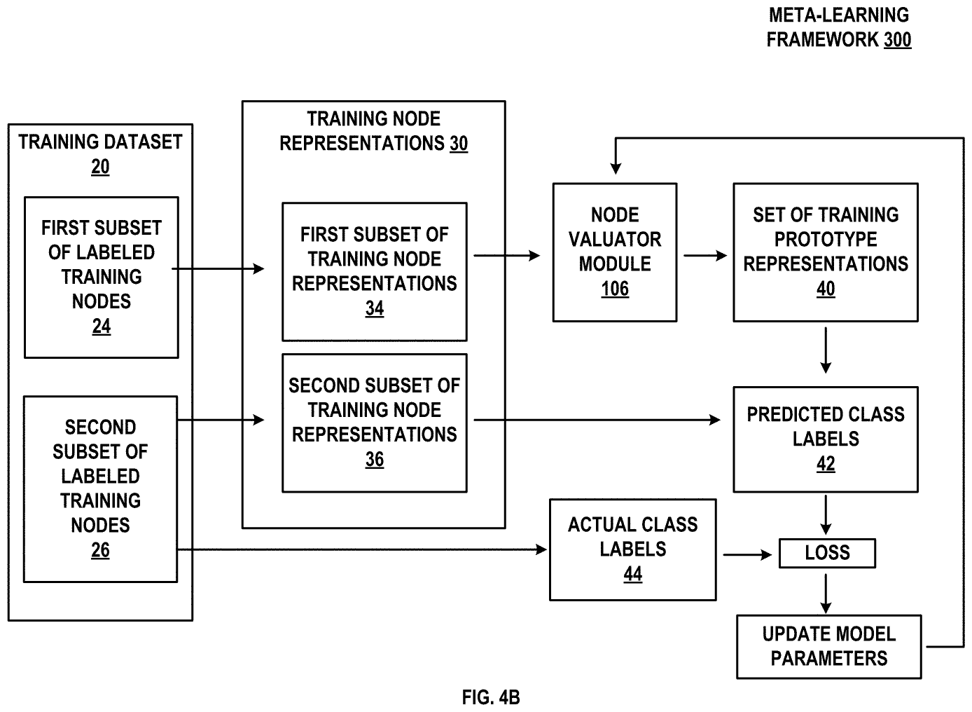

In another aspect, with additional reference to FIGS. 4A and 4B, modules of the system 100 can be trained by a meta-learning framework 300 that applies a semi-supervised episodic training process. The meta-learning framework 300 randomly samples a first subset of labeled training nodes 24 (e.g., a support set St), where each labeled training node 24 is associated with a training class of a plurality of training classes from a training dataset 20 (e.g., an attributed network similar to attributed network 10 and having an auxiliary class set Cₜᵣₐᵢₙ) for a plurality of learning iterations (e.g., episodes), and selects a subset of nodes within each class to act as the support set and a second subset of labeled training nodes 26 of the remainder to serve as query set Qₜ; note that while each labeled training node from the second subset of labeled training nodes 26 is associated with an actual classification label 44, the meta-learning framework 300 obscures this information when training the network encoder module 106 of the system 100. The network encoder module 106 determines a predicted classification label 42 for each labeled training node from the second subset of labeled training nodes 26, which is then compared against actual classification labels 44 for each labeled training node from the second subset of labeled training nodes 26. The meta-learning framework 300 iteratively adjusts model parameters of the system 100 (which can include the network encoder module 106) to minimize a loss between the predicted classification labels 42 and actual classification labels 44 for the second subset of labeled training nodes 26. In other words, the meta-learning framework 300 teaches the system 100 to generalize how to predict class labels of nodes of unseen networks where limited data is available by essentially showing the system 100 how to form different prototype representations of classes on many different auxiliary networks.

### 2.1—Episodic Training on Attributed Networks

As discussed and as shown in FIGS. 2, 4A and 4B, the system 100 employs meta-learning for training, which follows the prevailing episodic training paradigm. Specifically, the meta-learning framework 300 can train the system 100 over diverse meta-training tasks across a large number of episodes (e.g., through episodic training) rather than focusing only on the target meta-test task. The key idea of episodic training is to mimic the real test environment by sampling nodes from the training set of node classes Cₜᵣₐᵢₙ. The consistency between training and test environment alleviates the distribution gap and improves model generalization capability. Specifically, in each episode, the meta-learning framework 300 constructs an N-way K-shot meta-training task:

Sₜ={(v₁, y₁), (v₂, y₂) , . . . ,(vNxK, yNxK)},

Qₜ={(v₁^{*}, y₁^{*}), (v₂^{*}, y₁^{*}), . . . , (v^{*}NxM, y*NxM)}, (1)

[symbol]

ₜ={Sₜ, Qₜ},

where both the support set Sₜ (e.g., the first subset of labeled training nodes 24) and query set Qₜ (e.g., the second subset of labeled training nodes 26) of the meta-training task Tₜ are sampled from the training set of node classes Cₜᵣₐᵢₙ. The support set Sₜ includes K nodes from each class, while the query set Qₜ includes M query nodes sampled from the remainder of each of the N classes.

The whole training process is based on a set of T meta-training tasks [symbol] ₜᵣₐᵢₙ={Tₜ}ₜ^{T}=1. The meta-learning framework 300 trains the system 100 by minimizing a loss between predicted classification labels and actual classification labels for the query set Qt in each meta-training task Tₜ and goes episode-by-episode until convergence. In this way, the system 100 gradually collects meta-knowledge across those meta-training tasks and then can be naturally generalized to the meta-test task Tₜₑₛₜ={S, Q} with unseen classes Cₜₑₛₜ (e.g., a previously unseen network such as attributed network 10).

In contrast with conventional episodic training that constructs a pool of supervised meta-training tasks, in each episode, the meta-learning framework 300 samples N-way K-shot labeled nodes and masks the rest as unlabeled nodes. In this way, the meta-learning framework 300 can create a semi-supervised meta-training task with the partially labeled attributed network 10. By considering both labeled and unlabeled data and their interdependencies, the meta-learning framework 300 trains the system 100 to “learn” more expressive node representations for few-shot node classification during the meta-learning process.

### 2.2—Network Representation Learning

With reference to FIGS. 2-3C, for node classification tasks on a partially-labeled attributed network 10 having a plurality of labeled nodes 12 and a plurality of unlabeled nodes 14, the system 100 extracts a set of node representations 212 for each respective node 12 of the plurality of nodes 12 of the attributed network 10. The system 100 includes the network encoder module 104 that captures the data heterogeneity by extracting the set of node representations 212 expressive of the attributed network 10, including a set of labeled node representations 214 and a set of unlabeled node representations 216. In some implementations of the system 100, the network encoder module 104 possesses a GNN backbone (e.g., a plurality of GNN layers), which converts each respective node 12 in the attributed network 10 to a low-dimensional latent representation. In general, GNNs follow a neighborhood aggregation scheme, and the network encoder module 104 determines the set of node representations 212 by recursively aggregating and compressing node features from local neighborhoods. Briefly, a GNN layer of the network encoder module 104 can be defined as:

hₗ^{t}=COMBINE^{l}(hᵢ^{l-1},h_{Ni}^{l}),

h_{N}^{l}=AGGREGATE^{l}({hⱼ^{l-1}|∀j∈ [symbol] U vᵢ}), (2)

Where hᵢ^{l} is a node representation of node i at layer l and [symbol] is a set of neighboring nodes of vᵢ. COMBINE and AGGREGATE are two key functions of GNNs and have a series of possible implementations.

By stacking multiple GNN layers in the network encoder module 104, the system 100 can capture within the set of node representations 212 expressions of long-range node dependencies in the attributed network 10:

$$\begin{matrix}{H}^{1} = G N {N}^{1} ( A , X ) , \\ … \\ Z = GN {N}^{L} ( A , {H}^{L - 1} ) ,\end{matrix}$$

where Z is the resulting set of node representations 212 provided by the network encoder module 104. For simplicity, this disclosure will use f_{θ}(·) to denote the network encoder module 104 having L GNN layers.

Prototype Computation. With the set of node representations 212 from the network encoder module 104 including the set of labeled node representations 214 for the plurality of labeled nodes 14, the system 100 then aims to determine a prototype representation 220 of each class within the attributed network 10 using the plurality of labeled nodes 14. The idea of Prototypical Networks is followed, which encourages nodes of each class to cluster around a specific prototype representation of the class. As such, classification of an unlabeled node can be determined based on similarity to the prototype representation. Formally, the system 100 determines class prototype representations by:

P_{c}=PROTO ({Zᵢ|∀i∈S_{c}}) (4)

where S_{c} denotes the set of labeled examples from class c and PROTO is a prototype computation function. For instance, in vanilla Prototypical Networks, a “prototype” representation of each class is determined by taking the “average” of all embedded nodes belonging to that class:

$${p}_{c} = \frac{1}{\vert {S}_{c} \vert} {\sum }_{i ∈ {S}_{c}} {z}_{i} . \qquad ( 5 )$$

### 2.3—Node Importance Valuation

Despite its simplicity, directly taking mean or average vectors of embedded support instances as prototypes may not provide promising results. It not only neglects the fact that each node has a different significance in a network, but also makes the few-shot learning (FSL) model highly noise-sensitive because labeled data is severely limited. Therefore, the system 100 takes measures to refine class prototype representations in order to build a robust and effective FSL model.

To identify the informativeness of each labeled node 14 in the attributed network 10, the importance of a node is highly correlated with its neighbors' importance. Accordingly, the system 100 includes the network encoder module 106 g_{ϕ}(as shown in FIGS. 3A and 3C) that having a plurality of graph neural network layers 124, and estimates node importance scores for each respective labeled node 14 through a score aggregation layer 128 of one or more score aggregation layers 128 of the plurality of graph neural network layers 124, which can be defined as follows:

sᵢ^{l}=Σ_{j∈N}_{ᵢ}Uᵥ_{ᵢ}αᵢⱼ^{l}sⱼ^{l-1}, (6)

where sᵢ^{l} is a node importance score of node vᵢ in the l-th layer (l=1, . . . ,L). αᵢⱼ^{l} is the attention weight between nodes vᵢ and vₗ. The system 100 determines the attention weight αᵢⱼ^{l} through application of a shared attention mechanism:

$${α}_{i j}^{l} = \frac{exp ( LeakyReLU ( {a}^{T} [ {s}_{i}^{l - 1} \vert \vert {s}_{j}^{l - 1} ] )}{{\sum }_{k ∈ {N}_{i} ⋃ {v}_{i}} exp ( LeakyReLU ( {a}^{T} [ {s}_{i}^{l - 1} \vert \vert {s}_{k}^{l - 1} ] ] )} , \qquad ( 7 )$$

where II is a concatenation operator and a is a weight vector.

To determine an initial importance score sₗ⁰ for each labeled node 14, the network encoder module 106 includes the scoring layer 126 that compresses the features of each respective labeled node 14. In one implementation, the scoring layer is a feed-forward layer with tanh non-linearity. Specifically, the system 100 determines an initial importance score of a node vᵢ by:

sᵢ^{0 =tanh(}wₛ^{T}xᵢ+bₛ) (8)

where wₛ∈ [symbol] ^{d} is a learnable weight vector and bₛ∈ [symbol] ¹ is the bias.

Following the determination of the initial importance score sᵢ⁰ for each respective labeled node 14 by the scoring layer 126 of the network encoder module 106, the network encoder module 106 provides the initial importance scores to the one or more score aggregation layers 128, which each determine an updated importance score for each respective labeled node 14 though application of a shared attention mechanism to the importance score of the labeled node 14 as assigned by the previous score aggregation layer 128 with respect to one or more additional labeled nodes 14 of the plurality of labeled nodes 14 according to Eqs. 6 and 7 shown above.

Centrality Adjustment. The importance of a node positively correlates with its centrality in the graph. Given that the in-degree deg(i) of node vᵢ is a common proxy for its centrality and popularity, the network encoder module 106 defines the initial centrality C(i) of node vᵢ as:

C(i)=log(deg(i)+∈), (9)

where ∈ is a small constant. To compute the final importance score for node vᵢ (e.g., a labeled node 14), the network encoder module 106 applies a centrality adjustment operation to the updated importance score sᵢ^{L} from the final score aggregation layer 128, and applies a sigmoid non-linearity as follows:

\tilde{s}ᵢ=sigmoid(C(i)·sᵢ^{L}. (10)

In this way, the network encoder module 106 adjusts the importance of labeled examples in the support set S by making use of the additional information encoded in the network. By adjusting the centrality of labeled nodes used as prototypes from the support set S, where the “most important” prototype nodes descriptive of a class are at the center of a “cluster” on the graph, the system 100 can accurately generate the set of prototype representations 220 that enable the system 100 to classify each respective unlabeled node 16 within the query set Q (e.g., the set of unlabeled nodes 16) based on similarity of their associated unlabeled node representations 216 relative to the prototype representation 220 for the class (in other words, the system 100 can classify an unlabeled node 16 based on how its associated unlabeled node representation 216 “clusters” around a prototype representation 220 for a class).

### 2.4—Few-Shot Node Classification

After the network encoder module 106 determines the final importance scores for the plurality of labeled nodes 14, the system 100 first normalizes those scores using the softmax function:

$${β}_{i} = \frac{exp ( {\tilde{s}}_{i} )}{{\sum }_{k ∈ {s}_{c}} exp ( {\tilde{s}}_{k} )} , \qquad ( 11 )$$

where βᵢ represents a normalized weight of each support node Vᵢ. The system 100 then determines the refined set of prototype representations 220 by:

$${p}_{c} = {\sum }_{i ∈ {S}_{c}} {β}_{i} {z}_{i} . \qquad ( 12 )$$

As such, the system 100 can adjust the cluster locations to better represent the set of prototype representations 220 for classes in both the support set S (e.g., the plurality of labeled nodes 14) and unlabeled query set Q (e.g., the plurality of unlabeled nodes 16). The set of prototype representations 220 define a predictor fora class label of a query node vᵢ^{*}(e.g., an unlabeled node 16), which assigns a probability over each class c based on the distances (e.g., proximity or similarity) between an unlabeled node representation 216 of the query node vᵢ^{*}(e.g., the unlabeled node 16) and each prototype representation 220:

$$p ( c \vert {v}_{i}^{*} ) = \frac{exp ( - d ( {z}_{i}^{*} , {p}_{c} ) )}{{\sum }_{{c}^{′}} exp ( - d ( {z}_{i}^{*} , {p}_{{c}^{′}} ) )} \qquad ( 13 )$$

where d(·) is a distance metric function. Commonly, squared Euclidean distance is a simple and effective choice.

With additional reference to FIGS. 4A and 4B, during training of the network encoder module 106, the meta-learning framework 300 uses the above-described methods to essentially “teach” the network encoder module 106 how to generate refined prototype representations 220 by applying the above methodology to the training dataset 20 including a first subset of labeled training nodes 24 and a second subset of labeled training nodes 26 (whose labels are obscured) to yield a set of training node representations 30 (including a first subset of training node representations 34 and a second subset of training node representations 36). During training, the network encoder module 106 is applied to the first subset of training node representations 34 to generate a set of training prototype representations 40 and compares the second subset of training node representations 36 with the set of training prototype representations 40 to determine predicted classification labels 42 for each labeled training node of the second subset of labeled training nodes 26. These predicted classification labels 42 can be compared with actual classification labels 44 associated with the second subset of labeled training nodes 26 to update one or more parameters of the network encoder module 106.

Specifically, under the meta-learning framework 300, the objective of each meta-training task is to minimize a classification loss between predictions of the query set (e.g., the predicted classification labels 42) and the ground-truth (e.g., the actual classification labels 44). Specifically, the training loss can be defined as the average negative log-likelihood probability of assigning correct class labels:

$$ℒ = - \frac{1}{N \times M} {\sum }_{i = 1}^{N \times M} log ρ ( {y}_{i}^{*} \vert {v}_{i}^{*} ) . \qquad ( 14 )$$

During training, the meta-learning framework 30 minimizes the above loss function to learn a generic classifier and adjust various parameters of the network encoder module 106 for a specific meta-training task. The meta-learning framework 300 forms training episodes by randomly selecting a subset of classes from the auxiliary class set Cₜᵣₐᵢₙ (e.g., the training dataset 20), then selecting the first subset of labeled training nodes 24 within each class to act as the support set and the second subset of labeled nodes 26 of the remaining nodes within each class to serve as the query set. The meta-learning framework 300 then trains the system 100 on a considerable number of meta-training tasks, and generalization performance of the system 100 can be measured on the test episodes, which include nodes sampled from Cₜₑₛₜ instead of Cₜᵣₐᵢₙ. For each test episode, the system 100 uses the predictor of Eq. 13 for the provided support set S to classify each query node in the query set Q into a most likely class: yᵢ^{*}=argmax_{c}p(c|vᵢ^{*}). A detailed learning process of the system 100 enabled by the meta-learning framework 300 is presented in Algorithm 1.

Algorithm 1: Learning process of GPN.

```
Input: Attributed network G = (A, X), few-shot node classification
task [symbol]     = {S, Q}, training episodes T.
Output: Predicted labels of nodes in the query set Q.
  1 // Meta-training process
  2 while i < T do
  3 | Sample a meta-training task [symbol]     = {Sᵢ, Qᵢ}
  4 | Compute representations for the nodes in Sᵢ and Qᵢ;
  5 | Estimate importance scores for the nodes in Sᵢ;
  6 └ Minimize the meta-training loss according to Eq. (14);
  7 // Meta-test process
  8 Compute representations for the nodes in S and Q;
  9 Estimate importance scores for the nodes in Sᵢ;
10 Predict labels for the nodes in the query set Q;
```

As such, the system 100 employs GPNs disclosed herein to solve the problem of few-shot node classification on attributed networks. Specifically, to classify unlabeled nodes of the attributed network 10 the system 100 first extracts, at the network encoder module 104, the set of node representations 212 for each node 12 (including labeled nodes 14 and unlabeled nodes 16) in the attributed network 10 via multi-layered GNNs considering both node attributes and topological structure. Concurrently, the system 100 estimates, at the network encoder module 106 which is another GNN-based component, an informativeness of each labeled node 14 in the attributed network 10. By integrating those two information modalities, the system 100 learns highly informative prototype representations 220 for each class in a transferable metric space, where nodes 12 of the attributed network 10 that are “clustered” together can be interpreted as being within the same class and where prototype representations for each class are associated with a “centrality” of the associated cluster. In a further aspect, when learning the prototype representations 220 for each class, the system 100 can adjust a centrality of each cluster to determine the best prototype representation 220 for each class. Based on the set of prototype representations 220, the system 100 can determine a label of each query node (e.g., each unlabeled node 16 in the attributed network 10) by measuring its similarity (e.g., proximity to) with a respective prototype representation 220 for each class. The system 100 classifies unlabeled nodes 16 based on the class of the most similar prototype representation 220. Moreover, the system 100 can be trained through the meta-learning framework 300 which enables learning over diverse semi-supervised node classification tasks that can mimic the real test environment in a large number of episodes. As such, the system 100 can be effectively generalized to the target few-shot classification task. The empirical results over four real-world datasets demonstrate the effectiveness of the model versus the baseline methods in few-shot node classification.

### 3—Complexity Analysis

The system 100 includes two main components introduced in the previous sections. As both the network encoder module 104 and network encoder module 106 are built upon graph neural networks, the complexity of the GPN of the system 100 mainly depends on the specific underlying GNN architecture. For instance, the computational complexity of a graph convolutional network (GCN) layer is 0(|ε|dd′), where |ε| denotes the number of edges in the attributed network, d and d′ are the input feature size and output feature size, respectively. Note the complexity of the scoring layer is 0(|ν|dd′), and score aggregation layer is 0(|ν|+|ε|), where |ν| denotes the number of nodes in the network. Overall, as |ν|»|ε| in practice, the complexities of GPN models can be considered as linear with respect to the number of edges.

### 4—Experiments

In order to verify the effectiveness of the system 100, in this section, the experimental settings are first introduced and then the detailed experiment results are discussed.

### Experiment Settings

Evaluation Datasets. Due to the fact that few-shot node classification on graph-structured data remains an under-studied problem, it is worth mentioning that the existing benchmark datasets (e.g., Cora, Pubmed) for conventional node classification problem are not suitable for evaluating FSL models. The main reason is that FSL models usually need to be tested on many different classification tasks, while those datasets only contain limited node classes. To extensively evaluate the model performance on few-shot node classification, in the experiments, four public datasets are adopted with plenty of node classes, including:

Amazon-Clothing is a product network built with the products in “Clothing, Shoes and Jewelry” on Amazon. In this dataset, each product is considered as a node and its description is used to construct the node attributes. The substitutable relationship (“also viewed”) is also used to create links between products. The class label is defined as the low-level product category. For this dataset, 40/17/20 node classes are used for training/validation/test.

Amazon-Electronics is another Amazon product network which contains products belonging to “Electronics”. Similar to the first dataset, each node denotes a product and its attributes represent the product description. Note that here the system 100 uses the complementary relationship (“bought together”) between products to create the edges. The low-level product categories are used as class labels. For this dataset, 90/37/40 node classes are used for training/validation/test.

DBLP is a citation network where each node represents a paper, and the links are the citation relations among different papers. The paper abstracts are used to construct node attributes. The class label of a node is defined as the paper venue. For this dataset, 80/27/30 node classes are used for training/validation/test.

Reddit is a post-to-post graph constructed with data sampled from Reddit, which is used to evaluate the performance of the model on large-scale attributed networks. In this large-scale attributed network, posts are represented by nodes and two posts are connected if they are commented by the same user. Each post is labeled with it a community ID. For this dataset, 16/10/15 node classes are used for training/validation/test.

The statistics of the above datasets are summarized in Table 2. More details, such as data sources and how they are preprocessed, can be found below.

TABLE 2
Statistics of the evaluation datasets.

| Datasets | # nodes | # edges | # attributes | # labels |
|---|---|---|---|---|
| Amazon-Clothing | 24,919 | 91,680 | 9,034 | 77 |
| Amazon-Electronics | 42,318 | 43,556 | 8,669 | 167 |
| DBLP | 40,672 | 288,270 | 7,202 | 137 |
| Reddit | 232,965 | 11,606,919 | 602 | 41 |

Compared Methods. In the experiments, the model GPN is compared with related baseline methods, including

DeepWalk: It performs a stream of truncated vanilla random walks on the input graph and learns node embeddings from the sampled random walks.

node2vec: It extends DeepWalk with biased random walks to explore diverse neighborhoods.

GCN: This model learns latent node representations based on the first-order approximation of spectral graph convolutions.

SGC: It reduces the extra complexity of GCN by eliminating the non-linearity between the GCN layers and folding the convolution functions into a linear transformation.

PN: Prototypical Network is one of the widely used few-shot learning methods for image classification.

MAML: It is an optimization-based meta-learning method, which tries to learn a better model initialization from a series of meta-training tasks.

Meta-GNN: This baseline extends MAML to graph data by using a GNN base model.

The above baseline methods can be summarized into three categories: (1) random walk-based methods including two widely used unsupervised methods DeepWalk and node2vec. With the learned node representations, train a Logistic Regression classifier to perform node classification; (2) GNN-based methods including two state-of-the-art models GCN and GraphSAGE for semi-supervised node classification. (3) few-shot methods including PN, MAML and Meta-GNN. Specifically, PN and MAML are two representative few-shot learning models for data, while Meta-GNN is able to handle graph-structured data by integrating graph neural networks with meta-learning. Note that for the first two categories of methods, follow the way in to adapt those models to few-shot node classification scenarios.

Implementation of GPN. The system was implemented in PyTorch and the code is public. Specifically, the network encoder module 104 includes two GCN layers with dimension size 32 and 16, respectively. Both are activated with ReLU function. For the network encoder module 106, it includes one fully connected layer and two score aggregation layers. For each score aggregation layer, Leaky ReLU is used with a negative slope of 0.2 as the activation function. GPN is trained with Adam optimizer, whose learning rate is set to be α=0.005 initially with a weight decay of 0.0005. The coefficients for computing running averages of gradient and square are set to be β₁=0.9,β₂=0.999. To avoid overfitting, the dropout rate is finetuned and determine the value for each dataset based on the validation performance. For each dataset, the model is trained over 300 episodes with an early-stopping strategy.

TABLE 3
Averaged few-shot node classification results on four datasets w.r.t ACC and F1 (%).

| | Amazon-Clothing | | | | | | | | Amazon-Electronics | | | | | | | |
|---|---|---|---|---|---|---|---|---|---|---|---|---|---|---|---|---|
| | 5-way 3-shot | | 5-way 5-shot | | 10-way 3-shot | | 10-way 5-shot | | 5-way 3-shot | | 5-way 5-shot | | 10-way 3-shot | | 10-way 5-shot | |
| Methods | ACC | F1 | ACC | F1 | ACC | F1 | ACC | F1 | ACC | F1 | ACC | F1 | ACC | F1 | ACC | F1 |
| DeepWalk | 36.7 | 36.3 | 46.5 | 46.6 | 21.3 | 19.1 | 35.3 | 32.9 | 23.5 | 22.2 | 26.1 | 25.7 | 14.7 | 12.9 | 16.0 | 14.7 |
| node2vec | 36.2 | 35.8 | 41.9 | 40.7 | 17.5 | 15.1 | 32.6 | 30.2 | 25.5 | 23.7 | 27.1 | 24.3 | 15.1 | 13.1 | 17.7 | 15.5 |
| GCN | 54.3 | 51.4 | 59.3 | 56.6 | 41.3 | 37.5 | 44.8 | 40.3 | 53.8 | 49.8 | 59.6 | 55.3 | 42.3 | 38.4 | 47.4 | 48.3 |
| SGC | 56.8 | 55.2 | 62.2 | 61.5 | 43.1 | 41.6 | 46.3 | 44.7 | 54.6 | 53.4 | 60.8 | 59.4 | 43.2 | 41.5 | 50.0 | 47.6 |
| PN | 53.7 | 53.6 | 63.5 | 63.7 | 41.5 | 41.9 | 44.8 | 46.2 | 53.5 | 55.6 | 59.7 | 61.5 | 39.9 | 40.0 | 45.0 | 44.8 |
| MAML | 55.2 | 54.5 | 66.1 | 67.8 | 45.6 | 43.3 | 46.8 | 45.6 | 53.3 | 52.1 | 59.0 | 58.3 | 37.4 | 36.1 | 43.4 | 41.3 |
| Meta-GNN | 74.1 | 73.6 | 77.3 | 77.5 | 61.4 | 59.7 | 64.2 | 62.9 | 63.2 | 61.5 | 67.9 | 66.8 | 58.2 | 55.8 | 60.8 | 60.1 |
| GPN | 75.4 | 74.7 | 78.6 | 79.0 | 65.0 | 66.1 | 67.7 | 68.9 | 64.6 | 62.8 | 70.9 | 70.6 | 60.3 | 60.7 | 62.4 | 63.7 |
| | DBLP | | | | | | | | Reddit | | | | | | | |
| | 5-way 3-shot | | 5-way 5-shot | | 10-way 3-shot | | 10-way 5-shot | | 5-way 3-shot | | 5-way 5-shot | | 10-way 3-shot | | 10-way 5-shot | |
| Methods | ACC | F1 | ACC | F1 | ACC | F1 | ACC | F1 | ACC | F1 | ACC | F1 | ACC | F1 | ACC | F1 |
| DeepWalk | 44.7 | 43.1 | 62.4 | 60.4 | 33.8 | 30.8 | 45.1 | 43.0 | 26.7 | 26.1 | 30.1 | 29.7 | 17.6 | 17.1 | 18.8 | 18.6 |
| node2vec | 40.7 | 38.5 | 58.6 | 57.2 | 31.5 | 27.8 | 41.2 | 39.6 | 27.1 | 25.6 | 31.2 | 29.8 | 19.8 | 18.6 | 23.4 | 22.6 |
| GCN | 59.6 | 54.9 | 68.3 | 66.0 | 43.9 | 39.0 | 51.2 | 47.6 | 38.8 | 38.1 | 45.5 | 44.1 | 29.0 | 27.0 | 35.7 | 32.4 |
| SGC | 57.3 | 54.7 | 65.0 | 62.1 | 40.2 | 36.8 | 50.3 | 46.4 | 44.4 | 42.1 | 46.8 | 42.5 | 29.7 | 26.8 | 31.6 | 27.7 |
| PN | 37.2 | 36.7 | 43.4 | 44.3 | 26.2 | 26.0 | 32.6 | 32.8 | 34.6 | 33.3 | 37.6 | 36.4 | 19.8 | 18.0 | 23.3 | 21.4 |
| MAML | 39.7 | 39.7 | 45.5 | 43.7 | 30.8 | 25.3 | 34.7 | 31.2 | 29.1 | 26.8 | 31.1 | 29.7 | 15.2 | 12.2 | 17.9 | 15.6 |
| Meta-GNN | 70.9 | 70.3 | 78.2 | 78.2 | 60.7 | 60.4 | 68.1 | 67.2 | 60.8 | 58.3 | 62.7 | 61.2 | 44.9 | 42.1 | 51.5 | 47.1 |
| GPN | 74.5 | 73.9 | 80.1 | 79.8 | 62.6 | 62.6 | 69.0 | 69.4 | 65.5 | 66.2 | 68.4 | 69.0 | 53.4 | 55.8 | 57.7 | 59.2 |

For each dataset, the performance of all the algorithms on four few-shot node classification tasks, i.e., 5-way-3-shot, 5-way-5-shot, 10-way-3-shot, and 10-way-5-shot is evaluated. The query size is set as same as the support size in the experiments. Two widely used metrics are adopted: Accuracy (ACC) and Micro-F1 (F1) to evaluate performance. Each model is evaluated on 50 meta-test tasks and each meta-test task is randomly sampled from test node classes. The process is repeated 10 times and the averaged results are presented in Table 3. Higher values are better for all metrics. From the comprehensive views, the following observations were made.

A general observation is that the GPN achieves the best performance on all the few-shot tasks. For example, on the Amazon-Clothing dataset, GPN outperforms the best performing baseline Meta-GNN by 5.9% (ACC) under the 10-way-3-shot task. The improvements are even more substantial on the larger dataset Reddit. This result verifies that GPN is a powerful and reliable model to tackle the problem of few-shot node classification on attributed networks.

Overall, DeepWalk and node2vec largely fall behind other methods on few-shot node classification tasks. Those random walk-based methods need to train a supervised classifier (e.g., Logistic Regression) with learned node representations, which typically rely on a large number of labeled data for good performance. Similarly, GNN-based methods are unable to obtain competitive results on the few-shot node classification problem. Conventional GNN models are developed for semi-supervised node classification and could be easily overfitted with only a small number of labeled instances.

Despite the success of MAML and PN on few-shot image classification, however, both perform poorly on tasks. The main reason is that those methods cannot capture the de-pendency between nodes for learning expressive node representations, rendering unsatisfactory performance on few-shot node classification tasks.

By integrating the idea of meta-learning into graph neural networks, Meta-GNN achieves considerable improvements over other baseline methods on few-shot node classification in most cases. However, it is worth noting that its performance suffers a catastrophic decline on the Reddit dataset. One reasonable explanation is that optimization-based FSL approaches require extensive fine-tuning efforts for the target task, especially on those large-scale datasets.

### 5—Parameter Analysis & Ablation Study

In this section, extensive experiments are conducted to analyze the sensitivity of GPN to the number of node classes (N-way), size of the support set (K-shot), and query set size. To better understand the contribution of each component, another two methods GPN-naive and PN are also included for ablation study. Note that GPN-naive is a variant of GPN that excludes the network encoder module 106, and PN can be considered as a variant of GPN that excludes the network encoder module 106 and uses an MLP-based encoder.

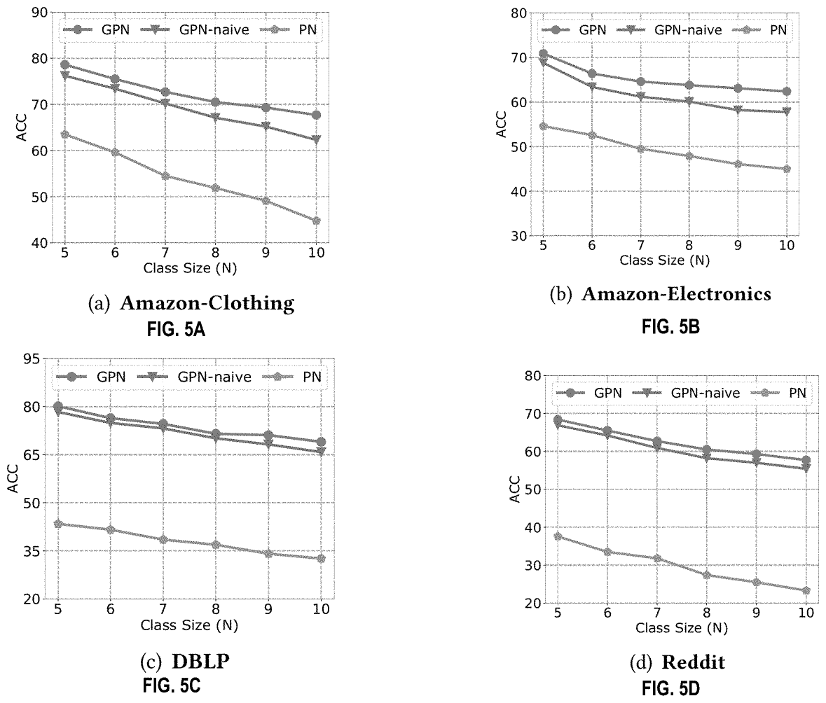

Effect of Class Size (N-way). First analyze the effect of the test class size, which is controlled by the parameter N. Here the shot number is kept as 5, and the performance changes of the three models are reported by setting different values of N. Results on four datasets in terms of Accuracy (ACC) are presented in FIGS. 5A-5D. From a comprehensive view, the performance of different models decreases as the test class size increases, which is in accordance with expectation. The main reason is that a larger number of test classes results in a wider variety of node classes to be predicted, which increases the difficulty of few-shot node classification. The performance of PN largely falls behind GPN and GPN-naive since it cannot capture the node dependency information without the GNN-based network encoder module 104. In addition to that, one can further observe that GPN consistently outperforms GPN-naive, and the performance margin increases when N becomes larger. It illustrates that the system GPN is more robust to the number of test classes, which validates the effectiveness of the network encoder module 106 in GPN for learning more representative class prototypes.

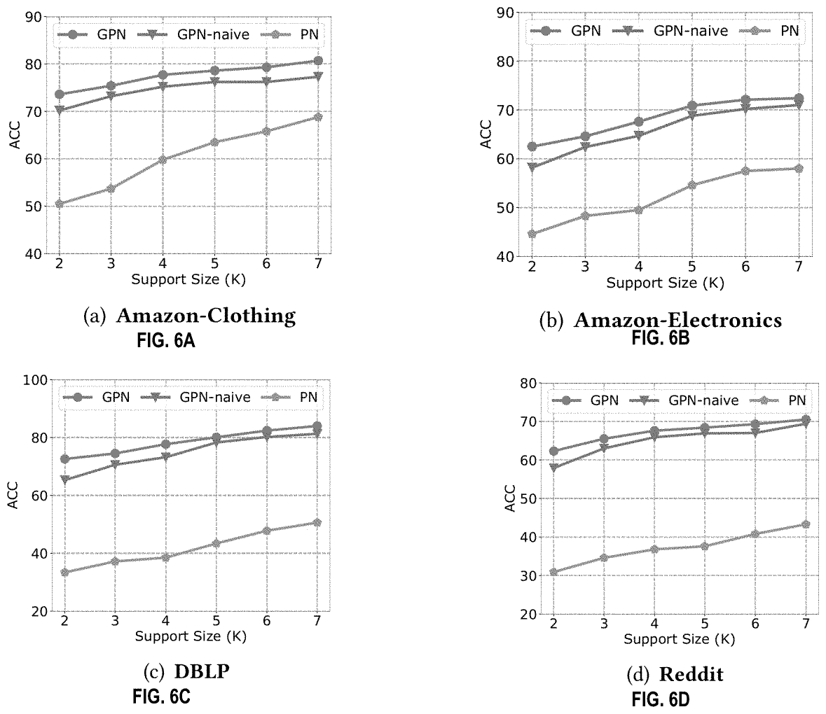

Effect of Support Size (K-shot). Next, the effect of the support size is investigated, which is represented by the shot number K. By changing the value of shot number K and setting way number N to 5, different model performances can be achieved. For each dataset, the results are reported in terms of Accuracy (ACC) in FIGS. 6A-6D. From the figure, one can clearly observe that the performance of all the models increase with the growth of K, indicating that larger support set can produce better prototypes for few-shot classification. PN is unable to achieve satisfactory results due to the inability of modeling attributed networks. More remarkably, the GPN was observed to be able to achieve larger improvements over GPN-naive when the support set size is small. One potential reason could be that GPN-naive is sensitive to noisy data, as it calculates prototype by averaging values over samples with equal weights. Thus, more data is expected to derive reliable prototypes. On the contrary, by estimating the informativeness of each labeled sample, GPN becomes more robust on noisy data and achieves better performance for few-shot node classification.

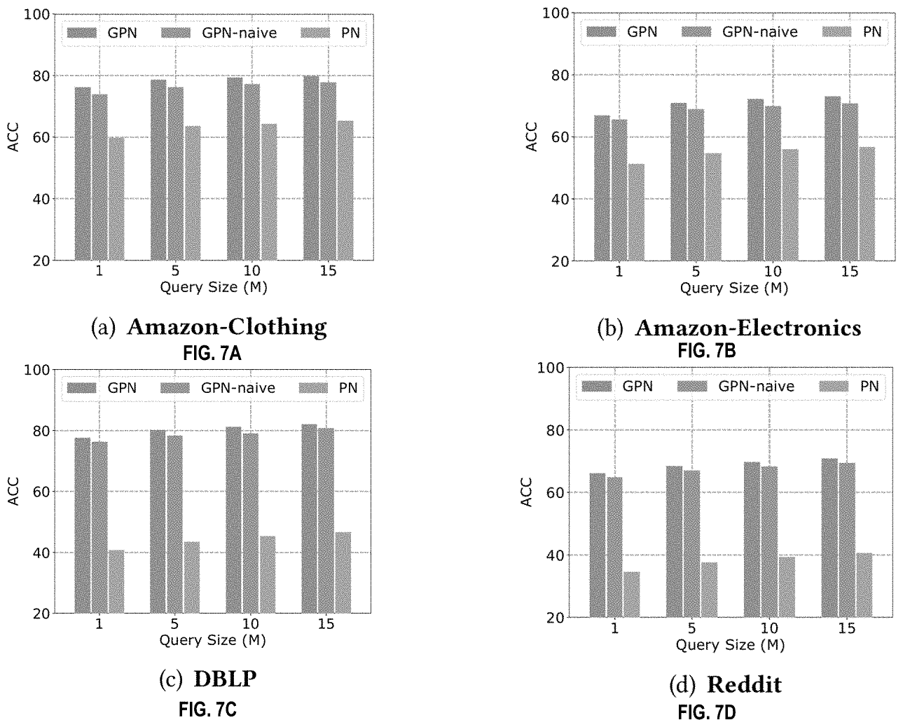

Effect of Query Size (M-query). Although it is a consensus to remain consistent between training and test phase in standard few-shot learning, previous research claims that not every system benefits the most from this identical setting. Hence, the influence of using different query size was examined during training. Here the 5-way 5-shot task was used as an example, then change the number of query nodes from each class and report the corresponding results in FIGS. 7A-7D. From the reported results, an increasing query size was observed during training can achieve performance gain on all the four datasets. One reasonable explanation is that a few-shot learning model can better adapt the knowledge from meta-training tasks with larger query set and further obtain better generalization ability on the target task.

### 6—Case Study

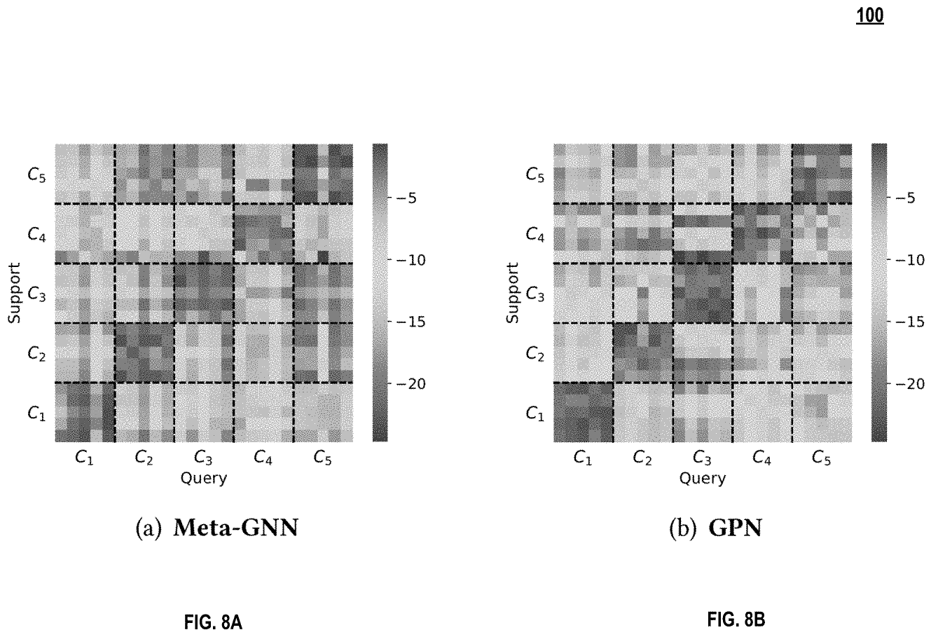

FIGS. 8A and 8B show the similarity matrix learned by the best performing baseline Meta-GNN and the approach on the DBLP dataset, with the same network encoder module 104 in a 5-way 5-shot task. Here the negative Euclidean distance is used as the similarity metric. Specifically, each cell includes 5×5 grids illustrating the divergence between two classes, as well as the intra-class similarities. To better visualize the results, for GPN, the weighted embedding of each support node is used instead of computing the class prototype. From the figure, one can observe that GPN can better capture the similarities between the support nodes and query nodes from a same class, which validates the robustness and effectiveness of the present approach.

All of the graphs in experiments are constructed from public data sources. In the following, details are provided on the construction of each graph.

Amazon-Clothing. This is a public product dataset containing the metadata of products in Amazon, ranging from May 1996 to July 2014. The dataset is truncated based on the top-level product category “Clothing, Shoes and Jewelry”. Both the product descriptions and substitutable relationships (“also viewed”) between products are included in the metadata. In addition, each product corresponds to a low-level category, e.g., Monopods, LED TVs and DVD Recorders. In this case, each product is denoted as a node and its low-level category is the node label. The classes with 100 to 1000 nodes were selected for evaluation and remove those isolated products. Bag-of-words model is applied on product description to obtain the attributes of each node.

Amazon-Electronics. This dataset is constructed with the products under the category “Electronics” in Amazon. Based on the metadata, the complementary relationships (“bought together”) between products are used to create the links. Similar to the previous dataset, the low-level category (e.g., Sunglasses, Garment Bags and Athletic Socks) of each product is used to decide its label. The classes with 100 to 1000 nodes were selected for evaluation and those isolated products were omitted.

DBLP. The public DBLP dataset (version v11) was used which covers information (e.g., abstract, authors, references and venue) for all the papers available on DBLP before May 2019. In the experiment, venues which have been lasting for at least 20 years and published 100 to 1000 papers were focused on. All the isolated nodes with no link are excluded. Then the bag-of-word model is applied on the abstract of each node to generate the node attributes.

Reddit. To construct this post-to-post graph, the public dataset sampled from Reddit is used with all the posts made in September 2014. Each post belongs to one of 50 large communities in Reddit. With the off-the-shelf 300-dimensional GloVe Common-Crawl word vectors, for each post, the embedding of post title, the average embedding of all the comments, the post's score and the number of comments are concatenated.

### 7—Methods

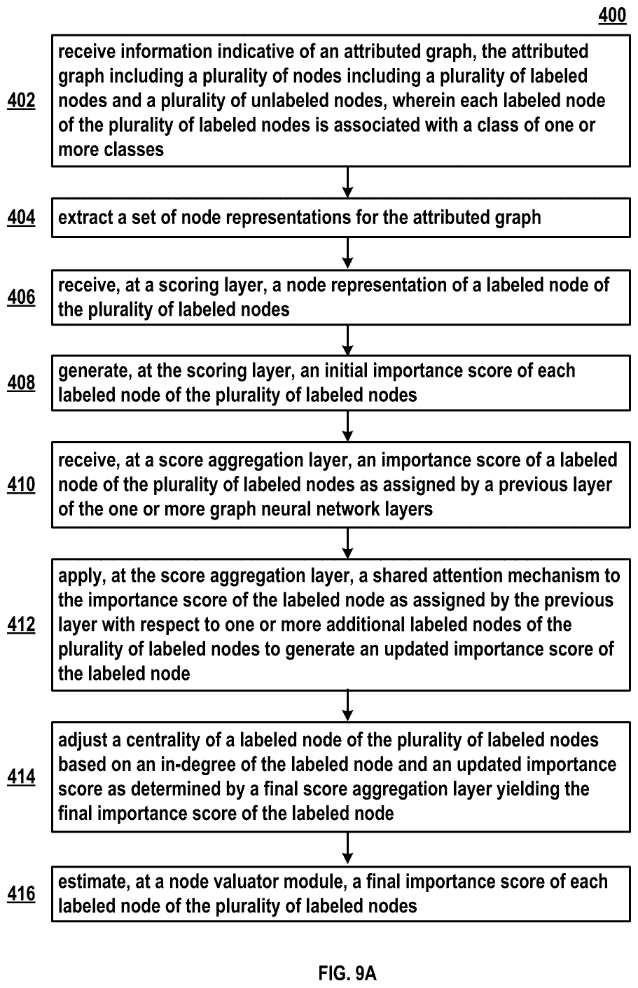

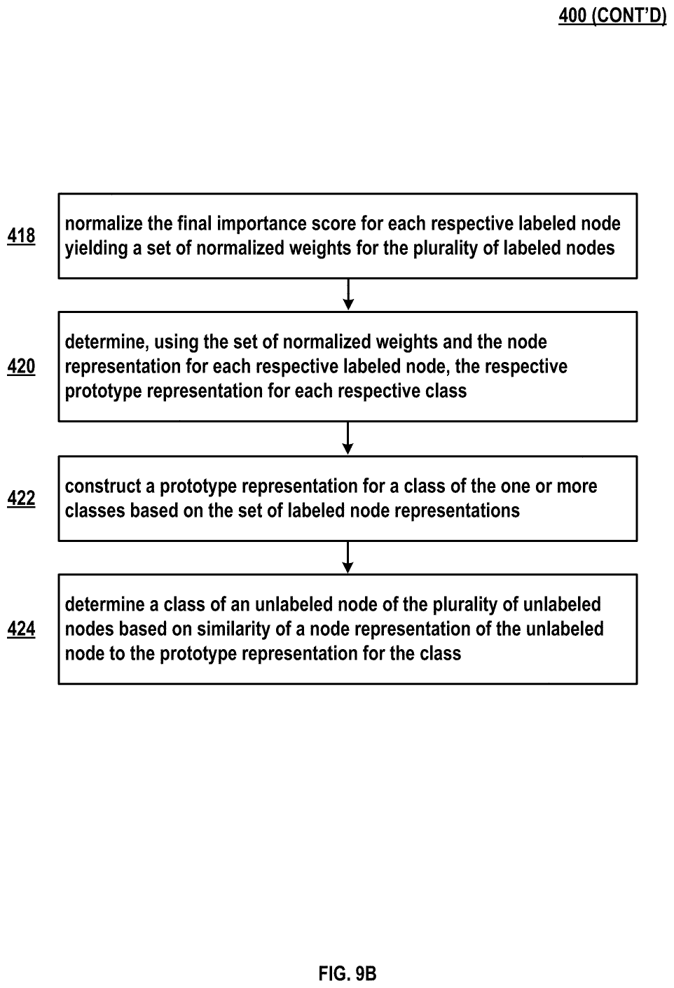

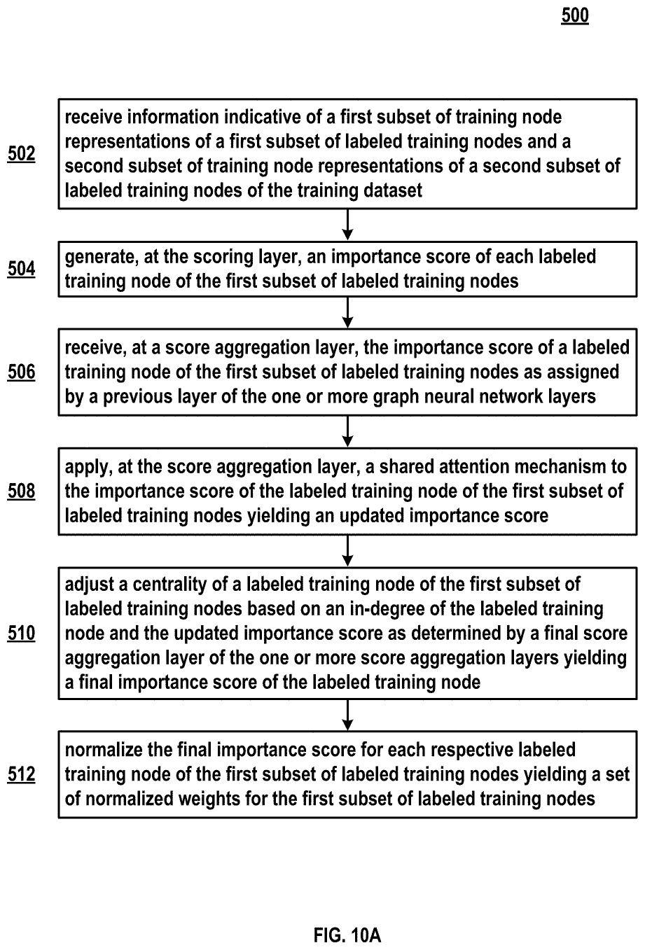

With reference to FIGS. 9A and 9B, a method 400 for classifying unlabeled nodes of an attributed network by the system 100 is provided.

Block 402 of method 400 includes receiving, at a processor in communication with a memory, information indicative of an attributed network, the attributed network including a plurality of nodes including a plurality of labeled nodes and a plurality of unlabeled nodes, wherein each labeled node of the plurality of labeled nodes is associated with a class of one or more classes.

Block 404 of method 400 includes extracting, at the processor, a set of node representations including a set of labeled node representations including a labeled node representation for each respective labeled node of the plurality of nodes of the attributed network and a set of unlabeled node representations including a unlabeled node representation for each respective unlabeled node of the plurality of nodes of the attributed network.

Block 406 of method 400 includes receiving, at the scoring layer formulated at the processor, a node representation of a labeled node of the plurality of labeled nodes.

Block 408 of method 400 includes generating, at the scoring layer formulated at the processor, an initial importance score of the plurality of labeled nodes.

Block 410 of method 400 includes receiving, at a score aggregation layer of the one or more score aggregation layers formulated at the processor, an importance score of a labeled node of the plurality of labeled nodes as assigned by a previous layer of the one or more graph neural network layers.

Block 412 of method 400 includes applying, at the score aggregation layer, a shared attention mechanism to the importance score of the labeled node as assigned by the previous layer with respect to one or more additional labeled nodes of the plurality of labeled nodes to generate an updated importance score of the labeled node.

Block 414 of method 400 includes adjusting, at the processor, a centrality of a labeled node of the plurality of labeled nodes based on an in-degree of the labeled node and an updated importance score as determined by a final score aggregation layer of the one or more score aggregation layers yielding the final importance score of the labeled node.

Block 416 of method 400 includes estimating, at a node valuator module formulated at the processor, a final importance score of each labeled node of the plurality of labeled nodes.

Block 418 of method 400 includes normalizing, at the processor, the final importance score for each respective labeled node of the plurality of labeled nodes yielding a set of normalized weights for the plurality of labeled nodes.

Block 42 of method 400 includes determining, using the set of normalized weights for the plurality of labeled nodes and the set of labeled node representations for each respective labeled node of the plurality of labeled nodes, the respective prototype representation for each respective class of the one or more classes.

Block 422 of method 400 includes constructing, at the processor, a prototype representation of a class of the one or more classes based on the set of labeled node representations.

Block 424 of method 400 includes determining, at the processor, a class of an unlabeled node of the plurality of unlabeled nodes based on similarity of an unlabeled node representation of the unlabeled node to the prototype representation of the class.

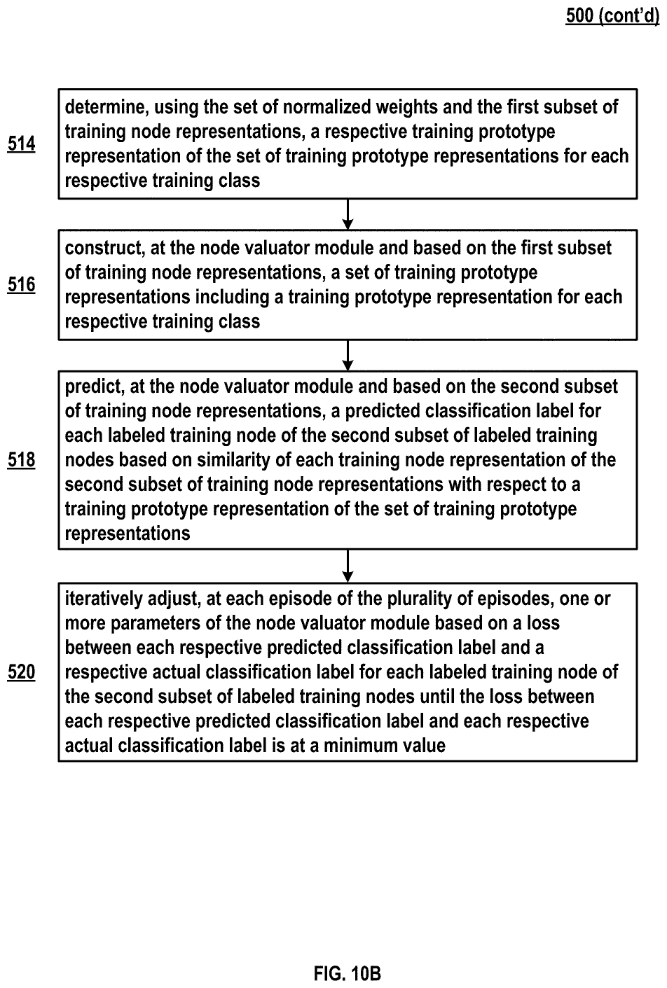

FIGS. 10A and 10B show a method 500 for training the system 100 to classify unlabeled nodes in an attributed network by the meta-learning framework 300.

Block 502 of method 500 includes receiving, at the processor, information indicative of a first subset of training node representations of a first subset of labeled training nodes of a plurality of nodes of a training dataset and a second subset of training node representations of a second subset of labeled training nodes of the plurality of nodes of the training dataset, wherein each labeled training node is associated with a training class of a plurality of training classes.

Block 504 of method 500 includes generating, at the scoring layer formulated at the processor, an importance score of each labeled training node of the first subset of labeled training nodes.

Block 506 of method 500 includes receiving, at a score aggregation layer of the one or more score aggregation layers formulated at the processor, the importance score of a labeled training node of the first subset of labeled training nodes as assigned by a previous layer of the one or more graph neural network layers.

Block 508 of method 500 includes applying, at the score aggregation layer, a shared attention mechanism to the importance score of the labeled training node of the first subset of labeled training nodes yielding an updated importance score.

Block 510 of method 500 includes adjusting, at the processor, a centrality of a labeled training node of the first subset of labeled training nodes based on an in-degree of the labeled training node and the updated importance score as determined by a final score aggregation layer of the one or more score aggregation layers yielding a final importance score of the labeled training node.

Block 512 of method 500 includes normalizing, at the processor, the final importance score for each respective labeled training node of the first subset of labeled training nodes yielding a set of normalized weights for the first subset of labeled training nodes.

Block 514 of method 500 includes determining, using the set of normalized weights and the first subset of training node representations, a respective training prototype representation of the set of training prototype representations for each respective training class of the plurality of training classes.

Block 516 of method 500 includes constructing, at the node valuator module formulated at the processor and based on the first subset of training node representations, a set of training prototype representations including a training prototype representation for each respective training class.

Block 518 of method 500 includes predicting, at the node valuator module formulated at the processor and based on the second subset of training node representations, a predicted classification label for each labeled training node of the second subset of labeled training nodes based on similarity of each training node representation of the second subset of training node representations with respect to a training prototype representation of the set of training prototype representations, wherein each labeled training node of the second subset of labeled training nodes is associated with an actual classification label.

Block 520 of method 500 includes iteratively adjusting, at each episode of the plurality of episodes, one or more parameters of the node valuator module based on a loss between each respective predicted classification label and each respective actual classification label for each labeled training node of the second subset of labeled training nodes until the loss between each respective predicted classification label and each respective actual classification label is at a minimum value.

### 8—Computer-Implemented System

FIG. 11 is a schematic block diagram of an example device 102 that may be used with one or more embodiments described herein, e.g., as a component of system 100.

Device 102 comprises one or more network interfaces 110 (e.g., wired, wireless, PLC, etc.), at least one processor 120, and a memory 140 interconnected by a system bus 150, as well as a power supply 160 (e.g., battery, plug-in, etc.).

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, device 102 may have limited memory or no memory (e.g., no memory for storage other than for programs/processes operating on the device and associated caches).

Processor 120 comprises hardware elements or logic adapted to execute the software programs (e.g., instructions) and manipulate data structures 145. An operating system 142, portions of which are typically resident in memory 140 and executed by the processor, functionally organizes device 102 by, inter alia, invoking operations in support of software processes and/or services executing on the device. These software processes and/or services may include node classification processes/services 190 described herein, which can include aspects of methods 400 and 500. Note that while node classification processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the node classification processes/services 190 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

1. A system, comprising:
one or more processors in communication with a memory, the memory including instructions, which, when executed, cause a processor of the one or more processors to:
receive, at the processor, information indicative of an attributed network, the attributed network including a plurality of nodes including a plurality of labeled nodes and a plurality of unlabeled nodes, wherein each labeled node of the plurality of labeled nodes is associated with a class of one or more classes;
extract, at the processor, a set of node representations including:
a set of labeled node representations including a labeled node representation for each respective labeled node of the plurality of nodes of the attributed network; and
a set of unlabeled node representations including an unlabeled node representation for each respective unlabeled node of the plurality of nodes of the attributed network;
construct, at the processor, a prototype representation for a class of the one or more classes based on the set of labeled node representations; and
determine, at the processor, a class of an unlabeled node of the plurality of unlabeled nodes based on similarity of a node representation of the unlabeled node to the prototype representation for the class.

2. The system of claim 1, wherein the memory further includes instructions, which, when executed, cause the processor to:
estimate, at a node valuator module formulated at the processor, a final importance score of each labeled node of the plurality of labeled nodes; and
determine, at the processor, a respective prototype representation for each class of the one or more classes based on the final importance score of each labeled node of the plurality of labeled nodes;
wherein the node valuator module includes a graph prototypical network formulated at the processor that includes one or more graph neural network layers including a scoring layer and one or more score aggregation layers.

3. The system of claim 2, wherein the memory further includes instructions, which, when executed, cause the processor to:
receive, at the scoring layer formulated at the processor, a node representation of a labeled node of the plurality of labeled nodes; and
generate, at the scoring layer formulated at the processor, an initial importance score of each labeled node of the plurality of labeled nodes;
wherein the scoring layer is a feed-forward layer having tanh non-linearity.

4. The system of claim 2, wherein the memory further includes instructions, which, when executed, cause the processor to:
receive, at a score aggregation layer of the one or more score aggregation layers formulated at the processor, an importance score of a labeled node of the plurality of labeled nodes as assigned by a previous layer of the one or more graph neural network layers;
apply, at the score aggregation layer, a shared attention mechanism to the importance score of the labeled node as assigned by the previous layer with respect to one or more additional labeled nodes of the plurality of labeled nodes; and
generate, at the score aggregation layer, an updated importance score of the labeled node.

5. The system of claim 2, wherein the memory further includes instructions, which, when executed, cause the processor to:
adjust, at the processor, a centrality of a labeled node of the plurality of labeled nodes based on an in-degree of the labeled node and an updated importance score as determined by a final score aggregation layer of the one or more score aggregation layers yielding the final importance score of the labeled node.

6. The system of claim 2, wherein the memory further includes instructions, which, when executed, cause the processor to:
normalize, at the processor, the final importance score for each respective labeled node yielding a set of normalized weights for the plurality of labeled nodes; and
determine, using the set of normalized weights for the plurality of labeled nodes and the node representation for each respective labeled node, the respective prototype representation for each respective class of the one or more classes.

7. The system of claim 2, wherein the memory further includes instructions, which, when executed, cause the processor to:
iteratively determine, by a processor of the one or more processors, one or more parameters of the node valuator module by a semi-supervised episodic training process, wherein the semi-supervised episodic training process includes training the node valuator module over a plurality of diverse meta-training tasks over a plurality of episodes.

8. The system of claim 7, wherein the memory further includes instructions, which, when executed, cause the processor to:
iteratively sample, at the processor and during an episode of the plurality of episodes, a first subset of labeled training nodes randomly selected from a training dataset, the training dataset including a plurality of labeled training nodes, each labeled training node being associated with a training class of a plurality of training classes;
extract, at the processor, a set of training node representations for each respective labeled training node of the plurality of labeled training nodes, including a first subset of training node representations corresponding to the first subset of labeled training nodes and a second subset of training node representations corresponding to a second subset of labeled training nodes of the plurality of labeled training nodes;
construct, at the node valuator module formulated at the processor and based on the first subset of training node representations, a set of training prototype representations including a training prototype representation for each respective training class of the plurality of training classes;
predict, at the node valuator module formulated at the processor, a predicted classification label for each labeled training node of the second subset of labeled training nodes based on similarity of each training node representation of the second subset of training node representations with respect to a training prototype representation of the set of training prototype representations, wherein each labeled training node of the second subset of labeled training nodes is associated with an actual classification label; and
iteratively determine, at the processor, a loss between each respective predicted classification label and each respective actual classification label for each labeled training node of the second subset of labeled training nodes.

9. The system of claim 8, wherein the memory further includes instructions, which, when executed, cause the processor to:
iteratively adjust, at each episode of the plurality of episodes, one or more parameters of the node valuator module based on the loss between each respective predicted classification label and each respective actual classification label for each labeled training node of the second subset of labeled training nodes until the loss between each respective predicted classification label and each respective actual classification label is at a minimum value.

10. A method, comprising:
receiving, at a processor in communication with a memory, information indicative of an attributed network, the attributed network including a plurality of nodes including a plurality of labeled nodes and a plurality of unlabeled nodes, wherein each labeled node of the plurality of labeled nodes is associated with a class of one or more classes;
extracting, at the processor, a set of node representations including:
a set of labeled node representations including a labeled node representation for each respective labeled node of the plurality of nodes of the attributed network; and
a set of unlabeled node representations including a unlabeled node representation for each respective unlabeled node of the plurality of nodes of the attributed network;
constructing, at the processor, a prototype representation of a class of the one or more classes based on the set of labeled node representations; and
determining, at the processor, a class of an unlabeled node of the plurality of unlabeled nodes based on similarity of an unlabeled node representation of the unlabeled node to the prototype representation of the class.

11. The method of claim 10, further comprising:
estimating, at a node valuator module formulated at the processor, a final importance score of each labeled node of the plurality of labeled nodes; and
determining, at the processor, a respective prototype representation for each class of the one or more classes based on the final importance score of each labeled node of the plurality of labeled nodes;
wherein the node valuator module includes a graph prototypical network formulated at the processor that includes one or more graph neural network layers including a scoring layer and one or more score aggregation layers.

12. The method of claim 11, further comprising:
receiving, at the scoring layer formulated at the processor, a node representation of a labeled node of the plurality of labeled nodes; and
generating, at the scoring layer formulated at the processor, an initial importance score of the plurality of labeled nodes;
wherein the scoring layer is a feed-forward layer having tanh non- linearity.

13. The method of claim 11, further comprising:
receiving, at a score aggregation layer of the one or more score aggregation layers formulated at the processor, an importance score of a labeled node of the plurality of labeled nodes as assigned by a previous layer of the one or more graph neural network layers;
applying, at the score aggregation layer, a shared attention mechanism to the importance score of the labeled node as assigned by the previous layer with respect to one or more additional labeled nodes of the plurality of labeled nodes; and
generating, at the score aggregation layer, an updated importance score of the labeled node.

14. The method of claim 11, further comprising:
adjusting, at the processor, a centrality of a labeled node of the plurality of labeled nodes based on an in-degree of the labeled node and an updated importance score as determined by a final score aggregation layer of the one or more score aggregation layers yielding the final importance score of the labeled node.

15. The method of claim 11, further comprising:
normalizing, at the processor, the final importance score for each respective labeled node of the plurality of labeled nodes yielding a set of normalized weights for the plurality of labeled nodes; and
determining, using the set of normalized weights for the plurality of labeled nodes and the set of labeled node representations for each respective labeled node of the plurality of labeled nodes, the respective prototype representation for each respective class of the one or more classes.

16. The method of claim 11, further comprising:
iteratively determining, by a processor, one or more parameters of the node valuator module by a semi-supervised episodic training process, wherein the semi-supervised episodic training process includes training the node valuator module over a plurality of diverse meta-training tasks over a plurality of episodes.

17. The method of claim 16, further comprising:
iteratively sampling, at the processor and during an episode of the plurality of episodes, a first subset of labeled training nodes randomly selected from a training dataset, the training dataset including a plurality of labeled training nodes, each labeled training node being associated with a training class of a plurality of training classes;
extracting, at the processor, a set of training node representations for each respective labeled training node of the plurality of labeled training nodes, including a first subset of training node representations corresponding to the first subset of labeled training nodes and a second subset of training node representations corresponding to a second subset of labeled training nodes of the plurality of labeled training nodes;
constructing, at the node valuator module formulated at the processor and based on the first subset of training node representations, a set of training prototype representations including a training prototype representation for each respective training class of the plurality of training classes;
predicting, at the node valuator module formulated at the processor, a predicted classification label for each labeled training node of the second subset of labeled training nodes based on similarity of each training node representation of the second subset of training node representations with respect to a training prototype representation of the set of training prototype representations, wherein each labeled training node of the second subset of labeled training nodes is associated with an actual classification label; and
iteratively determining, at the processor, a loss between each respective predicted classification label and each respective actual classification label for each labeled training node of the second subset of labeled training nodes.

18. The method of claim 17, further comprising:
iteratively adjusting, at each episode of the plurality of episodes, one or more parameters of the node valuator module based on the loss between each respective predicted classification label and each respective actual classification label for each labeled training node of the second subset of labeled training nodes until the loss between each respective predicted classification label and each respective actual classification label is at a minimum value.

19. A method, comprising:
iteratively determining, by a processor, one or more parameters of a node valuator module by a semi-supervised episodic training process, wherein the semi-supervised episodic training process includes training the node valuator module over a plurality of diverse meta-training tasks over a plurality of episodes, including:
receiving, at the processor, information indicative of a first subset of training node representations of a first subset of labeled training nodes of a plurality of nodes of a training dataset and a second subset of training node representations of a second subset of labeled training nodes of the plurality of nodes of the training dataset, wherein each labeled training node is associated with a training class of a plurality of training classes;
constructing, at the node valuator module formulated at the processor and based on the first subset of training node representations, a set of training prototype representations including a training prototype representation for each respective training class;
predicting, at the node valuator module formulated at the processor and based on the second subset of training node representations, a predicted classification label for each labeled training node of the second subset of labeled training nodes based on similarity of each training node representation of the second subset of training node representations with respect to a training prototype representation of the set of training prototype representations, wherein each labeled training node of the second subset of labeled training nodes is associated with an actual classification label; and
iteratively adjusting, at each episode of the plurality of episodes, one or more parameters of the node valuator module based on a loss between each respective predicted classification label and each respective actual classification label for each labeled training node of the second subset of labeled training nodes until the loss between each respective predicted classification label and each respective actual classification label is at a minimum value;
wherein the node valuator module includes a graph prototypical network formulated at the processor that includes one or more graph neural network layers including a scoring layer and one or more score aggregation layers.

20. The method of claim 19, further comprising:
generating, at the scoring layer formulated at the processor, an importance score of each labeled training node of the first subset of labeled training nodes;
receiving, at a score aggregation layer of the one or more score aggregation layers formulated at the processor, the importance score of a labeled training node of the first subset of labeled training nodes as assigned by a previous layer of the one or more graph neural network layers;
applying, at the score aggregation layer, a shared attention mechanism to the importance score of the labeled training node of the first subset of labeled training nodes yielding an updated importance score;
adjusting, at the processor, a centrality of a labeled training node of the first subset of labeled training nodes based on an in-degree of the labeled training node and the updated importance score as determined by a final score aggregation layer of the one or more score aggregation layers yielding a final importance score of the labeled training node;
normalizing, at the processor, the final importance score for each respective labeled training node of the first subset of labeled training nodes yielding a set of normalized weights for the first subset of labeled training nodes; and
determining, using the set of normalized weights and the first subset of training node representations, a respective training prototype representation of the set of training prototype representations for each respective training class of the plurality of training classes.
